(19) United States
(12) Patent Application Publication
(10) Pub. No.: US 2006/0108186 A1
(43) Pub. Date: May 25, 2006

(54) Air brake slack adjustment tool

(76) Inventor: Benjamin J. Tibbin, Moorpark, CA (US)

Correspondence Address: THE INVENTORS NETWORK, INC., 332 ACADEMY STREET, CARNEGIE, PA, 15106, US

(21) Appl. No.: 10/993,351

(22) Filed: Nov. 22, 2004

(51) Int. Cl. F16D 65/54

(52) U.S. Cl. 188/196 R; 188/206 R

(57) ABSTRACT

An air brake slack adjustment tool for measuring and adjusting the clearance of brake rods of an air brake assembly so that the air brakes are set within specifications for consistent braking operation includes an elongated handle portion, a base portion integral with the handle portion, a pair of lateral rests extending from the base portion for supporting and encompassing a portion of the slack adjuster during air brake adjustment, and an arm having a hook portion that hooks around the slack adjuster to obtain leverage for retracting the slack adjuster to measure piston rod clearance and then making the required brake adjustment by turning an adjustment nut on the slack adjuster.

### FIELD OF THE INVENTION

The present invention pertains to the adjustment and setting of automotive vehicle air brakes, and more particularly pertains to a tool for adjusting and setting the clearance and slack of the brake rod and slack adjuster between the brake-on and brake-off positions for air brake assemblies.

### BACKGROUND FOR THE INVENTION

A standard air brake assembly used on each wheel, or wheel pairs, for a vehicle, such as a tractor-trailer, includes an air chamber permanently mounted on a non-rotating portion of the axle structure adjacent on of the wheels (or wheel-pairs). A reciprocable piston is mounted within a cylinder disposed within the air chamber, and the piston is moved in one direction by the force of compressed air delivered to the cylinder and which is controlled by a valve operated by the vehicle driver. Upon applying the brakes, the compressed air causes the piston rod of the piston to move, and connected to one end of the piston rod by a clevis is a mechanism called slack adjuster. The slack adjuster is pivotally mounted at its larger end to a camshaft. The pivotal movement of the slack adjuster transmits torque through the camshaft to rotate an S-shaped cam that is fixedly secured to the opposite end of the camshaft. The rotation of the S-shaped cam then transmits a force through the cam-follower rollers that are mounted to the brake shoes thus forcing the brake shoes apart so that the brake pads mounted thereon can contact the brake drum thereby bringing the vehicle to a stop.

The brake shoes are preset to move a predetermined minimum distance before the brake pads impinge against the interior surface of the brake drum, and this distance denotes the slack in the pivotal movement of the slack adjuster. As the brake drum and brake pads wear through use, the slack adjuster has to pivot a farther distance to apply the brakes, and thus the range of slack adjuster movement increases. However, this range of motion must be delimited so that it does not exceed a certain maximum amount, and for this reason the slack adjuster includes a mechanical means for adjusting and resetting the range of its angular motion on the camshaft and relative to the S-shaped cam. Thus, the slack adjuster is not directly mounted on the camshaft but, instead, it is rotatably mounted on a worm gear that has internal splines that interconnect with splines on the end of the camshaft to prevent the worm gear from rotating relative to the camshaft. The slack adjuster can rotate on the worm gear only within a limited extent within a range determined by the engagement of gear teeth on the outer surface of the worm gear with a worm mounted in a fixed location within the slack adjuster. The worm rotates on its axis that is perpendicular to the axis of the camshaft. Generally the worm has a polygonal head, and the head is accessible from outside the slack adjuster to allow the worm to be rotated on its axis by a socket wrench. Excess slack is taken up by rotating the head to adjust the angle of the slack adjuster to the appropriate position thereby causing the S-shaped cam to commence applying force to the cam follower rollers concomitant with the movement of the piston rod out of the air chamber—the brake-on position—a short distance that is generally between ½ inches and ¾ inches from the position of the piston rod when in the brake-off position.

It should be noted that certain types of air brake assemblies include what are referred to as self-adjusting slack adjusters. This type of slack adjuster includes sensors for detecting the amount of slack in the brakes, and the sensors are electrically interconnected to some type of mechanical actuating means for rotating the worm in order to take up the excess slack.

Recent state and federal regulations, such as the Department of Transportation's 1998 edict, mandate that all truck drivers must be able to measure, adjust and set the air brakes of the vehicles they own, operate and drive. Thus the air brakes need to be checked daily, and certainly before each trip, to determine if the slack each air brake assembly is within or exceeds the safe working maximum limits. All of the brake shoes must be properly adjusted and set so that they all apply the same amount of pressure at the same time to the brake drums for bringing the vehicle to a safe, smooth and controlled stop. In addition to the daily checking of the air brake assemblies by the truck drivers, mechanics check the slack adjusters of the air brake assemblies on a regular schedule—and this means in summer and winter, and in good weather as well as inclement and uncomfortable weather. In view of this critical vehicle maintenance procedure in checking and, if necessary, properly adjusting and setting the slack adjusters of the air brake assembly, the prior art discloses a number of devices and tools for checking, measuring and adjusting the slack for properly setting the brakes of an air brake assembly.

For example, the Sebalos patent (U.S. Pat. No. 4,685,164) discloses an air brake adjustment tool that includes a main body, an offset handle portion and a channel grip member sized to receive the slack adjuster whereby leverage is applied to pull on the slack adjuster for measuring the stroke of the piston rod.

The Kreikle et al. patent (U.S. Pat. No. 4,864,900) discloses a testing and adjusting tool for air brake cams that includes a handle having a pair of jaws one of which engages the cam actuating lever for providing leverage in testing and measuring cam lever clearance.

The Jagt patent (U.S. Pat. No. 5,181,440) discloses a manually operable tool for measuring brake rod travel for air brake systems, and includes a handle pivotally mounted to an l-shaped member with the l-shaped member having forks with indicia for measuring the travel distance of the brake rod.

The Senters patent (U.S. Pat. No. 5,271,115) discloses a brake slack adjuster and tire tester tool that includes a main handle member, a hook member and a plate-shaped tester assembly attached to one end of the handle member for pivoting the rocking arm assembly for testing the slack of the air brake system.

The Dawson patent (U.S. Pat. No. 5,613,412) discloses a slack check tool for checking the slack in air brakes, and includes a handle, a curved holding member and a hook that cooperate to check the slack in the mechanism that actuates the s-shaped cam of an air brake system.

Nonetheless, despite the ingenuity of the above devices, there remains a need for a slack adjuster tool that can be easily and quickly used by any trucker or mechanic to properly adjust and set the vehicle's air brakes.

### SUMMARY OF THE INVENTION

The present invention comprehends an air brake slack adjustment tool for setting the proper range of slack adjuster motion and brake piston rod travel of an air brake assembly so that the air brakes of the vehicle, such as a tractor-trailer, operate within proper safety guidelines for consistently maintaining a high level of vehicle safety.

The slack adjustment tool includes an elongated handle portion and a base portion integrally formed to the handle portion. Laterally extending from the base portion is a pair of rests that are placed against the slack adjuster during the process of adjusting and setting the air brake. In addition, an arm having a distal hook portion extends from the handle portion for either hooking onto the slack adjuster or for inserting the hook portion into one of push rod holes of the slack adjuster so that leverage can be applied to the tool for making the appropriate air brake adjustment. The hook portion also includes lines or indicia 3/32 of an inch apart for measuring tire tread depth, and the end of the handle portion also includes a socket tab for fitting onto certain sized sockets or for use with a socket adapter. Once the tool is positioned on the slack adjuster the truck driver can pull on the handle portion thereby retracting the slack adjuster so that the amount of travel of the brake piston rod can be measured. If the air brakes are out of adjustment by more than two inches as determined by the amount of brake piston rod travel, the truck driver can adjust the adjusting nut of the brake piston rod or the adjusting screw of the slack adjuster. These adjustments will shorten the travel distance of the brake piston rod and the slack adjuster thereby bringing the air brake within the proper operating specifications. The truck driver will perform the above adjustments on all the vehicle's air brakes to make certain that all the air brakes are set the same within and within mandated limits.

It is an objective of the present invention to provide an air brake slack adjustment tool that allows truck drivers and mechanics to easily and quickly measure, adjust and set air brakes as necessary to comply with state and federal transportation safety requirements.

It is another objective of the present invention to provide an air brake slack adjustment tool that enables just one individual to adjust and set the air brakes as necessary, and which can be easily carried and stored by the truck driver at all times.

It is still yet another objective of the present invention to provide an air brake slack adjustment tool that allows the individual to complete the entire process of adjusting and setting the vehicle's air brakes in not more than ten minutes thereby saving a considerable amount of time and physical effort.

Still yet another objective of the present invention is to provide an air brake slack adjustment tool that allows for convenient, on-the-spot air brake adjustment to facilitate compliance with federal regulations that all truck drivers must be able to adjust their own air brakes.

A still further objective of the present invention is to provide an air brake slack adjustment tool that allows the trucker or mechanic to measure, adjust and properly set the air brakes that include self-adjusting mechanisms as part of their air brake assembly.

These and other objects, features and advantages will become apparent to one skilled in the art upon a perusal of the following detailed description read in conjunction with the accompanying drawing figures.

### BRIEF DESCRIPTION OF THE DRAWINGS

FIG. 1 is a perspective view of the present invention illustrating the air brake slack adjustment tool disposed in the operative position for measuring and adjusting the piston rod of the air brake assembly;

FIG. 2 is a perspective view of the present invention illustrating the air brake slack adjustment tool;

FIG. 3 is a side elevational view of the present invention illustrating the disposition of the air brake slack adjustment tool when first placed upon the mechanism of the air brake assembly for adjusting and setting the clearance of the piston rod of the air brake assembly;

FIG. 4 is a side elevational view of the present invention illustrating the pivotal motion of the air brake slack adjustment tool in adjusting the clearance of the piston rod of the air brake assembly; and

FIG. 5 is a side elevational view of the present invention illustrating the placement of the air brake slack adjustment tool on an air brake assembly that can be a self-adjusting air brake assembly.

### DETAILED DESCRIPTION OF THE PREFERRED EMBODIMENT

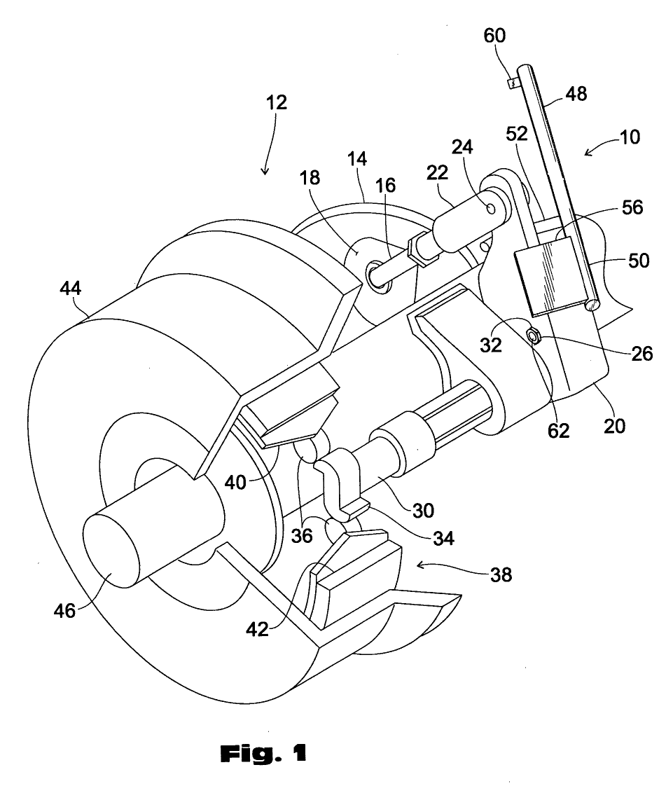

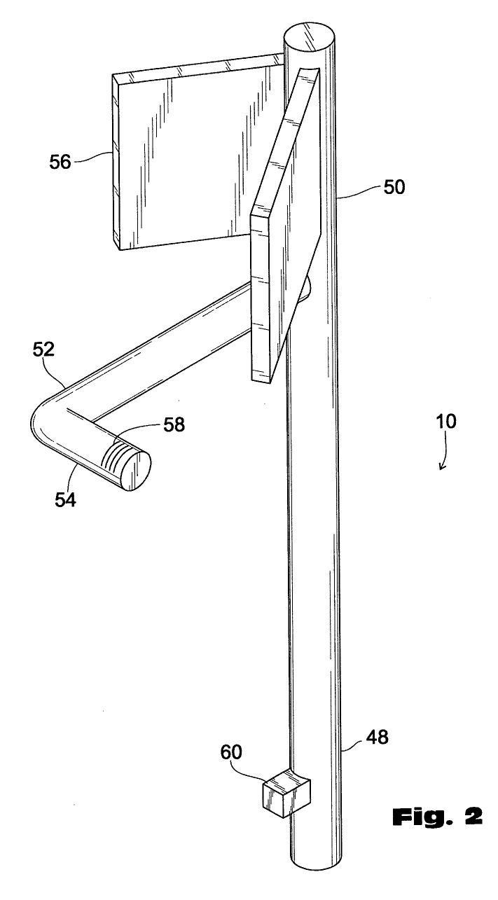

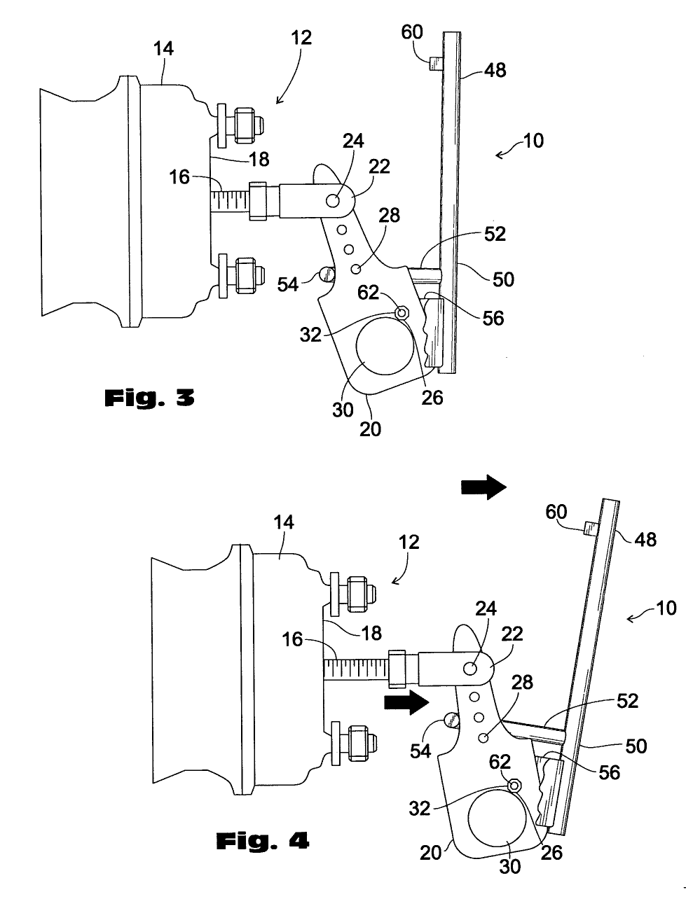

Illustrated in FIGS. 1-5 is a slack adjustment tool 10 that enables a single individual, such as a truck driver or mechanic, to measure, adjust and set the air brakes within proper specifications for an automotive vehicle, such as a tractor-trailer. With reference to FIG. 1, a representative air brake assembly 12 is shown that includes a brake actuating air chamber or air cylinder 14 connected to a source of compressed air (not shown) for reciprocating or moving a piston (not shown). The movement of the piston in turn causes the movement of a piston or brake rod 16 that is mounted to the piston and extends outwardly past the face wall 18 of the air chamber 14. Thus when the air brake assembly 12 is disposed to the brake-on position, the longitudinal movement of the piston throws the piston rod 16 outward to pivot a lever arm or slack adjuster 20 for engaging the brakes. Conversely when the air brake assembly 12 is disposed in the brake-off position, the piston rod 16 is partially withdrawn within the air chamber 14 thereby pivoting the slack adjuster 20 in the opposite direction for disengaging the brakes. The externally projecting end of the piston rod 16 is attached to a clevis 22, and pivotally mounted to the clevis 22 by a clevis pin 24 is the slack adjuster 20. The slack ajduster 20 includes an adjusting screw and nut assembly 26 for adjusting the slack of the slack adjuster 20 as will be hereinafter further described. To provide flexibility in positioning the slack adjustment tool 10 for adjusting the air brake assembly 12, the slack adjuster 20 can include one or more push rod holes 28 as shown for illustrative purposes in FIGS. 3 and 4.

As shown in FIGS. 1-3, the large end of the slack adjuster 20 is rotatably mounted to a camshaft 30 through an internal splined worm and worm gear arrangement (not shown) that are conventional in air brake assembly designs. The slack adjuster 20 is adjusted by turning the adjustment nut 32 in concert with the use of the slack adjustment tool 10. Mounted to the opposite end of the camshaft 30 is an S-shaped cam 34, and the S-shaped cam 34 engages a pair of cam rollers or followers 36 for selectively disposing the air brake assembly to the brake-on position or the brake-off position. More specifically, rotation of the S-shaped cam 34 in a first direction causes the S-shaped cam 34 to engage the cam followers 36 to actuate the brakes 38 that include brake shoes 40 and pads 42 to contact the inner surface of the brake drum 44 mounted on the wheel axle 46 for braking the vehicle. Contrawise, rotation of the S-shaped cam 34 in the opposite direction causes the cam followers 36 to withdraw the brake 38 from the brake drum 44 thereby disposing the air brake assembly 12 to the brake-off position.

In typical air brake systems and assemblies the longitudinal movement, extension, travel or clearance distance of the piston rod 16 outwardly from the face wall 18 of the air chamber 14 is normal operation is approximately ½ to ¾ of inch as measured between the position of the piston rod 16 when it is retracted within the air chamber 14 during brake-off and the maximum extension of the piston rod 16 outwardly from the face wall 18 of the air chamber 14 during brake-on when the brakes 38 engage the brake drum 44. In addition to the above range of minimum and maximum movement of the piston rod 16 between the brake-off and brake-on position, the rotational movement or clearance of the slack adjuster 20 on the camshaft 30 should be approximately 1 and ½ inches to 2 inches as determined between the brake-on and brake-off positions. Thus, if more than 1 and ½ inches is allowed full power to the brakes 38 may not be applied, while if less clearance exists there is the danger of the brakes 38 binding up even if they are not being applied. If the brakes 38 are beyond the maximum clearance, the slack adjustment tool 10 is used to take up the slack in the air brake assembly; if insufficient clearance exists the slack adjustment tool 10 is used to adjust the slack adjuster 20 to provide the necessary clearance for the brakes 38. This adjustment to bring the air brake assembly 12 within specifications is done for each air brake assembly 12 for each wheel or wheel pair for the vehicle so that all the air brake assemblies 12 are adjusted and set to the same clearance and same specifications.

Thus, the slack adjustment tool 10 shown in FIGS. 1-5 is a hand tool for measuring and determining the slack adjuster 20 clearance when performing brake inspections on vehicles such as tractor-trailers. The slack adjustment tool 10 is manufactured from steel and approximately eight inches long and two inches wide. The tool 10 includes a handle portion 48 and an integral base portion 50. Extending from the base portion 50 is an arm 52 for hooking onto the slack adjuster 20 for the measurement and adjustment thereof. The arm 52 terminates with a hook portion 54 that actually hooks over the slack adjuster 20, or, with some types of slack adjusters, can be inserted into the appropriate push rod hole 28. Projecting outwardly from the base portion 50 are at least two square-shaped rests 56 that encompass and rest against a portion of the slack adjuster 20 during the measurement and adjustment process. The rests 56 are spaced from each other at an angular distance that ism equal to or less than an acute angle. It should be noted that the arm 52 is not located in either plane as defined by the rests 56. In addition, the tip or end of the hook portion 54 includes indicia 58 spaced at 3/32 of an inch for gauging the tire depth. Adjacent the end of the handle portion 48 is a socket tab 60 capable of fitting either ⅜ of an inch sockets or for use with a ½ inch adapter of a ½ inch socket set.

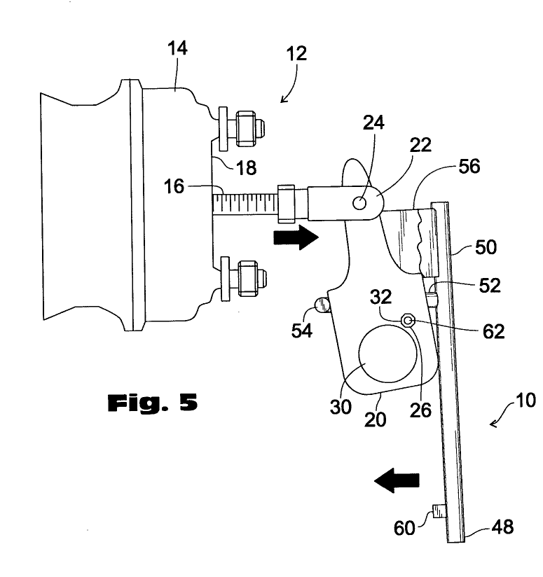

In order to measure the travel of the piston rod 16 to determine if the brake 38 is within the safety guidelines to maintain consistent air brake operation, one individual—the mechanic or truck driver—will first install the hook portion 54 of the tool 10 about the slack adjuster 20 as shown in FIG. 3 and then pull out the adjustment screw 62. On self-adjusters the hook portion 54 of the tool 10 can be installed between the self-adjuster air chamber and the slack adjuster 20 while for slack adjusters 20 with one or more push rod holes 28, the hook portion 54 can be inserted in the appropriate push rod hole 28. The rests 56 of the tool 10 cup and encompass the larger portion of the slack adjuster 20 adjacent the camshaft 30. The truck driver then pulls on the handle portion 48 of the tool 10, as shown in FIG. 4, thereby retracting the slack adjuster 20 for measuring the piston rod 16 clearance for that air brake assembly 14. Leverage is provided by the hook portion 54 of the arm 52 hooking onto the slack adjuster 20 allowing the pivotal movement of the slack adjuster 20 on the camshaft 30. FIG. 5 shows an alternate positioning of the tool 10 on the slack adjuster 20 to obtain leverage for retracting the piston rod 16 and pivoting the slack adjuster 20. If the clearance of the piston rod 16 exceeds two inches, the trucker adjusts the adjustment nut 32 to bring the piston rod 16 clearance within specifications with the slack adjuster 20 still in the position as shown in FIG. 4. Completion of the adjustment sets the clearance for the piston rod 16 and the slack adjuster 20, and removal of the slack adjustment tool 10 allows the slack adjuster 20 to return to the brake-off position, as shown in FIG. 3, within specifications. This process of adjustment is undertaken for all the air brake assemblies 12 for all the vehicle's wheels so that all the brakes 38 are set to the guidelines and regulations.

The above invention has been described with reference to a specific embodiment, and it will be obvious to those skilled in the art the numerous alterations, modifications, and variations will be possible and practicable to those skilled in the art without departing from the spirit of this invention or the scope of the appended claims.

I claim:

1. An air brake slack adjustment tool for adjusting the slack in an air brake assembly that includes a movable piston rod extending from the face wall of an air chamber and that is pivotally connected to a slack adjuster that interconnects with an S-shaped cam that actuates the air brake to the brake-on and brake-off positions, the tool comprising:
a manually graspable elongated handle portion;
a base portion integrally formed to the handle portion and in axial alignment therewith;
a pair of spaced-apart rests that laterally extend from the base portion and which are capable of encompassing a portion of the slack adjuster;
an arm extending from the base portion and non-planar with respect to the planes defined by each rest;
the arm having a hook portion capable over hooking over the slack adjuster during the process of measuring and adjusting the slack thereof; and
the rests placed on either side of the slack adjuster with the hook portion of the arm hooking onto the slack adjuster whereupon the individual can manually pull on the handle portion to rotate the slack adjuster and pull the piston rod out from the face wall of the air chamber to determine the amount of clearance of the piston rod and the slack of the slack adjuster so that an adjustment can be made for bringing the piston rod and the slack adjuster within specifications for consistent air brake operation when the air brake is disposed to the brake-on and brake-off positions.

2. The air brake slack adjustment tool of claim 1 wherein the hook portion includes indicia in the form of markings that are spaced at least 3/32 of an inch for gauging tire depth.

3. The air brake slack adjustment tool of claim 2 wherein the handle portion includes socket tab capable of fitting ⅜ of an inch sockets or a ½ inch adapter for a ½ inch socket set.
